(19) United States
(12) Patent Application Publication
(10) Pub. No.: US 2026/0031653 A1
(43) Pub. Date: Jan. 29, 2026

(54) MACHINE TO WEARABLE POWER TRANSFER SYSTEM AND METHOD FOR POWERING WEARABLE DEVICES THROUGH A HUMAN BODY

(71) Applicant: Quasistatics Inc., West Lafayette, IN (US)

(72) Inventors: Shreyas Sen, West Lafayette, IN (US); Arunashish Datta, West Lafayette, IN (US); Lingke Ding, Lafayette, IN (US)

(21) Appl. No.: 18/783,729

(22) Filed: Jul. 25, 2024

(51) Int. Cl. H02J 50/00; H02J 50/40; H02J 50/80; H02J 50/90

(52) U.S. Cl. CPC H02J 50/005; H02J 50/40; H02J 50/80; H02J 50/90

(57) ABSTRACT

The present invention relates to a machine to wearable power transfer system and method for powering wearable devices through a human body. The system includes a transmitting power source coupled to a ground terminal of earth. The transmitting power source is configured to transmit power signals to wearable devices using one of an Electro-Quasistatic Human Body Powering and using a body-assisted power transfer. Further, the system includes a conducting medium communicatively coupled to the transmitting power source. The conducting medium is configured to transfer the power signals from the transmitting power source to the one or more wearable devices. The system includes at least one wearable receiver communicatively coupled to the conducting medium. The at least one wearable receiver is configured to receive the power signals from the transmitting power source through the conducting medium and charge a power unit of the wearable receiver using the power signals.

### TECHNICAL FIELD

Embodiments of the present disclosure generally relate to wearable devices and technologies, and more particularly relates to machine to wearable power transfer system and method for powering wearable devices through a human body.

### BACKGROUND

The miniaturization of computing has led to a surge in wearable devices. With new wearables constantly emerging, managing the charging of multiple devices on a single person becomes increasingly cumbersome. For these wearable devices, achieving perpetual operation and eliminating the need for frequent charging would be highly desirable.

This has fueled extensive research into wireless powering and energy harvesting techniques. With increasing number of wearable devices around the body, energy harvesting, and wireless powering has become paramount in improving user experience in applications like activity tracking and continuous health monitoring using healthcare accessories by reducing the need for charging each individual device. The current state-of-the-art harvested energy in wearable devices is limited by reliable available ambient power, size of the harvester and safety limits in case of intentional powering. Further, intentional powering methodologies like radiofrequency and ultrasound-based powering are inefficient due to high path loss in Non-Line-of-Sight scenarios due to absorption by the body.

Further, traditional methods of ambient energy harvesting, such as using mechanical, thermal, or radiative sources (photovoltaic, thermoelectric, piezoelectric, or ambient radio frequency), face limitations. These limitations stem from the scarcity of readily available ambient energy and the restricted size of wearable devices for efficient harvesting.

Furthermore, the availability of reliable ambient energy is often inconsistent due to factors like environmental conditions, the location of the wearable on the body, and the power density present. As a result, researchers have explored intentional powering methodologies using targeted radio frequency beams. However, these directed beams present their own challenges. However, directed radio frequency beams are restricted by distance of charging from the source and safety limits as sufficient received power may require dangerous levels of electromagnetic exposure. The effectiveness of such beams diminishes with distance from the source, and achieving sufficient power transfer may require unsafe levels of electromagnetic exposure.

Therefore, a need exists for a novel wireless powering solution that overcomes the limitations of both traditional ambient energy harvesting and directed radio frequency beams. Therefore, there is a need in the art to provide a machine to wearable power transfer system and method for powering wearable devices through a human body to address the aforementioned deficiencies in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a machine to wearable power transfer system for powering wearable devices through a human body. The machine to wearable power transfer system includes a transmitting power source coupled to a ground terminal of earth. The transmitting power source is configured to transmit power signals to one or more wearable devices using one of an Electro-Quasistatic Human Body Powering and using a body-assisted power transfer. Further, the machine to wearable power transfer system includes a conducting medium communicatively coupled to the transmitting power source. The conducting medium is configured to transfer the power signals from the transmitting power source to the one or more wearable devices using a human body communication network. The one or more wearable devices includes at least one wearable receiver. The machine to wearable power transfer system further includes at least one wearable receiver communicatively coupled to the conducting medium. The at least one wearable receiver is configured to receive the power signals from the transmitting power source through the conducting medium via the human body communication network and charge a power unit of the at least one wearable receiver using the power signals.

Another aspect of the present disclosure includes a machine to wearable power transfer method for powering wearable devices through a human body. The machine to wearable power transfer method includes transmitting, by a transmitting power source, power signals to one or more wearable devices using one of an Electro-Quasistatic Human Body Powering and using a body-assisted power transfer. Further, the machine to wearable power transfer method includes transferring, by a conducting medium communicatively coupled to the transmitting power source, the power signals from the transmitting power source to the one or more wearable devices using human body communication network. The one or more wearable devices comprise at least one wearable receiver. Further, the machine to wearable power transfer method includes receiving, by the at least one wearable receiver, the power signals from the transmitting power source through the conducting medium via the human body communication network and charging a power source of the at least one wearable receiver using the power signals.

Yet another aspect of the present disclosure provides a non-transitory computer-readable medium comprising machine-readable instructions that are executable by a processor to perform the method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1A-B illustrates an example network architecture for implementing a machine to wearable power transfer system for powering wearable devices through a human body, in accordance with an embodiment of the present disclosure.

FIG. 2 illustrates an example block diagram of a wearable device, such as those shown in FIG. 1, for receiving power signals from a transmitting source and wirelessly charging a power source using the power signals, in accordance with an embodiment of the present disclosure.

FIG. 3 illustrates an example graphical representation of a comparative results of machine to wearable EQS resonance with traditional wearable to wearable and EQS regime, in accordance with an embodiment of the present disclosure.

FIG. 4 illustrates an example block diagram of a Machine-to-Wearable Electro-Quasistatic Resonant Human Body Powering channel, in accordance with an embodiment of the present disclosure.

FIG. 5 illustrates an example circuit diagram representation of a Machine-to-Wearable Electro-Quasistatic Resonant Human Body Powering channel, in accordance with an embodiment of the present disclosure.

FIG. 6 illustrates an example graphical representation of a narrowband channel for the ground connected transmitter, a wearable transmitter and a wearable receiver, in accordance with an embodiment of the present disclosure.

FIG. 7A illustrates an example schematic representation of a floor-based earth's ground connected powering methodology using Electro-Quasistatic Resonant Human Body Powering, in accordance with an embodiment of the present disclosure.

FIG. 7B illustrates an example schematic representation of a wall-connected powering methodology using Electro-Quasistatic Resonant Human Body Powering, in accordance with an embodiment of the present disclosure.

FIG. 8 illustrates an example graphical representation of experimental results with a floor-based earth's ground connected powering source, in accordance with an embodiment of the present disclosure.

FIG. 9 illustrates an example flow chart depicting an example process of powering wearable devices through a human body, in accordance with an embodiment of the present disclosure.

FIG. 10 illustrates an example schematic representation of a load sensing circuit, in accordance with an embodiment of the present disclosure.

FIG. 11 illustrates an example schematic representation of a shoe based wearable computing unit in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments described herein provide a machine to wearable power transfer system and method for powering wearable devices through a human body. The present system uses a human body as a common medium connecting wearable device, as a channel to transfer power. The use of a powering source strongly coupled to the earth's ground is used to reduce the channel loss of the Human Body Powering channel. Further, at the receiver end, the use of inductive cancellation of parasitic capacitances provides low channel losses increasing efficiency of power transfer. Further, higher power delivery is possible due to the transmitting source being a wall connected unit. The proposed powering methodology may deliver mW-scale power to wearable devices for long channels of more than 1 meter. The proposed methodology allows to capably power a new, extended range of wearable devices across the human body, bringing a step closer to enabling battery-less perpetual operation using Human Body Power transfer. The proposed powering method also allows modulated powering to perform simultaneous powering and communication to transfer control sequences or data between the earth's ground coupled device and a wearable device.

In an embodiment, the machine to wearable power transfer system for powering wearable devices through a human body comprises a transmitting power source coupled to a ground terminal of earth. The transmitting power source is configured to transmit power signals to one or more wearable devices using one of an Electro-Quasistatic Human Body Powering and using a body-assisted power transfer. The machine to wearable power transfer system further comprise a conducting medium communicatively coupled to the transmitting power source. The conducting medium is configured for transferring the power signals from the transmitting power source to the one or more wearable devices using a human body communication network. The one or more wearable devices comprise at least one wearable receiver. The machine to wearable power transfer system comprises the at least one wearable receiver communicatively coupled to the conducting medium. The at least one wearable receiver is configured to receive the power signals from the transmitting power source through the conducting medium via the human body communication network.

The machine to wearable power transfer system further comprises a signal plate comprising one of a floor-based signal plate and a wall-based signal plate on which a human steps on to transmit the power through body.

The transmitting power source is configured to simultaneously transmit the power signals at a plurality of frequencies to power the one or more wearable devices operating at different resonant frequencies by tuning an inductor on a receiver end used for inductive cancellation. The transmitting power source is configured to transfer the power signals at multiple frequencies to power a single wearable receiver at different resonant frequencies as a function of varying parasitic capacitances. The parasitic capacitances for the at least one wearable receiver change with variation in the position and a posture of the one or more wearable devices. The resonant frequencies of the transmitting power source and the resonant frequencies of the at least one wearable receiver is synchronized using an initiation sequence and a feedback mechanism.

The transmitting power source is further configured to transmit one of control sequences and a data along with the power signals for simultaneous communication and powering of the one or more wearable devices.

The transmitting power source is in close proximity to the earth's ground with a capacitive coupling and the transmitting power source transfers the power signals at one of a frequency of less than or equal to 30 MHz, and at a frequency between 1 MHz and 1 GHz.

The transmitting power source is a table-top device with a capacitive coupling to the earth's ground.

The at least one wearable receiver uses resonant peaking by cancelling parasitic impedances in the channel, wherein the resonant peaking uses a combination of a receiver side resonance and a transmitter side resonance for optimal power transfer.

The machine to wearable power transfer system further comprises a narrowband frequency hopping powering source for transmitting the power signals at a plurality of frequencies and the narrowband frequency hopping powering source is configured to change a transmitter frequency for transmitting higher range power signals at a plurality of frequencies based on varying receiver resonant frequencies.

The machine to wearable power transfer system further comprises a load sensing on the transmitting power source configured to selectively transfer the power signals based on one of a person's presence on the transmitting power source and a code-based transmission for identifying authorized users.

The machine to wearable power transfer system further comprises a shoe-mounted computer unit placed in close proximity to the transmitting power source. The shoe-mounted computer unit is configured to receive power and communication signals from the transmitting power source.

The transmitting power source is configured to select the best mode of power transfer from a plurality of power transfer methods. The conducting medium is the human body.

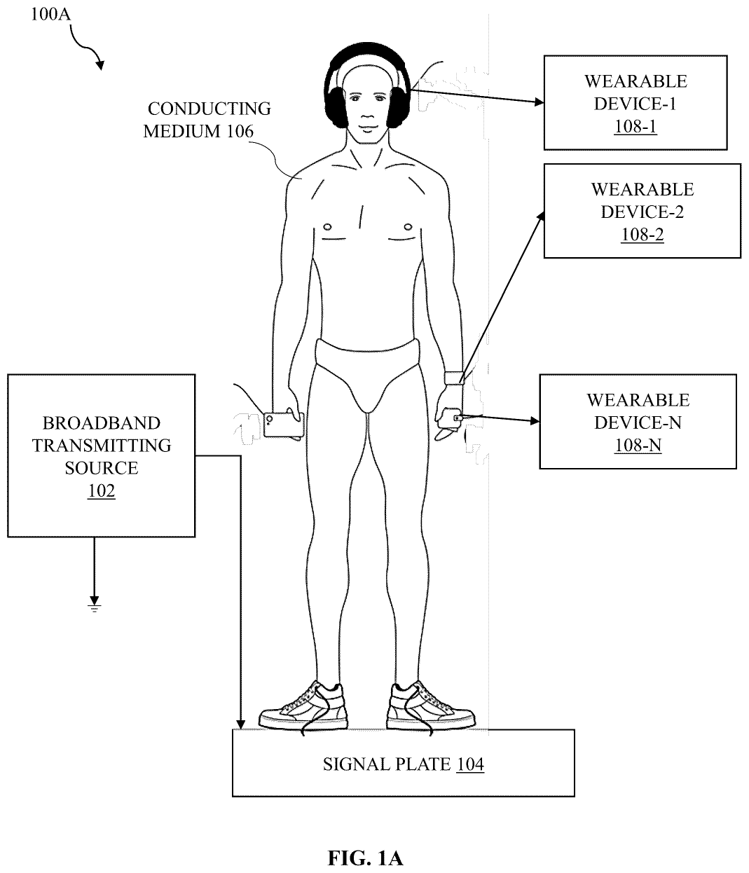

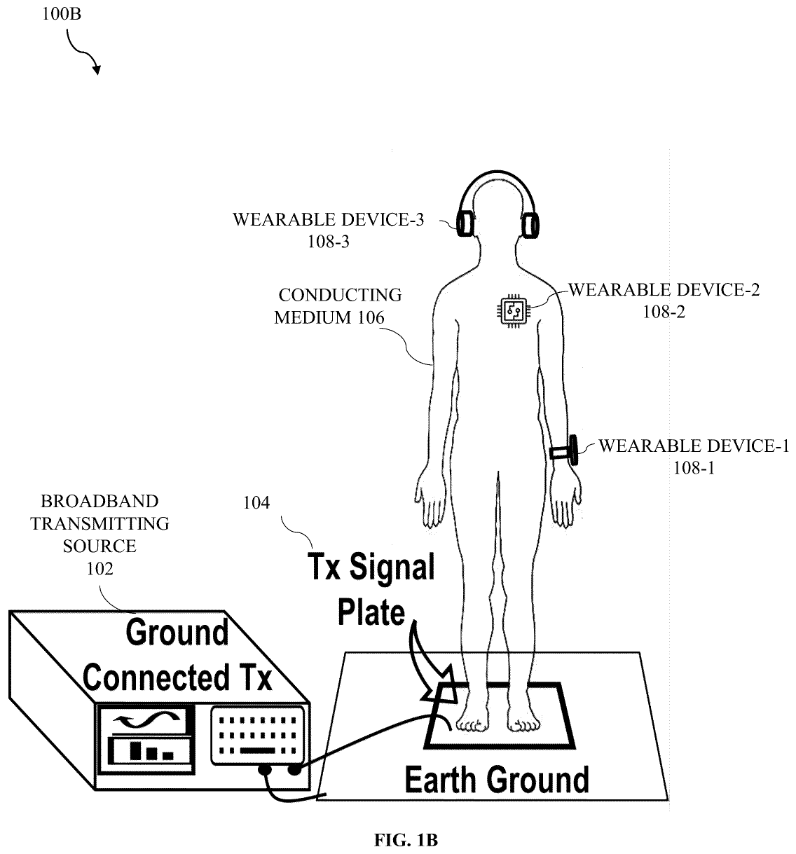

Referring now to the drawings, and more particularly to FIG. 1 through FIG. 9, where similar reference characters denote corresponding features consistently throughout the figures, there are shown preferred embodiments, and these embodiments are described in the context of the following exemplary system and/or method.

FIG. 1A-B illustrates an example network architecture 100a for implementing a machine to wearable power transfer system for powering wearable devices 108A-N through a human body 106, in accordance with an embodiment of the present disclosure. As illustrated in FIG. 1A, the network architecture 100a may include a broadband transmitting source 102. In an example embodiment, the broadband transmitting source 102 may include, for example, but not limited to earth's ground coupled device comprising powering source having a direct contact with the earth's ground or is a ground connected device. Alternatively, the broadband transmitting source 102 may be a wall-connected with strong coupling to earth's ground. Furthermore, the broadband transmitting source 102 may be in close proximity to the earth's ground with a large capacitive coupling to the earth's ground. In another alternate embodiment, the broadband transmitting source 102 may be a table-top device with a large capacitive coupling to the earth's ground.

Further, the broadband transmitting source 102 may be connected to one or more wearable devices 108-1-N (collectively referred herein as one or more wearable devices 108 or referred herein as wearable receiver 108) via a network 106. In an example embodiment, the network 106 (may be referred to as conducting medium 106 or communication channel 106 or human body 106) may be a human body acting as a communication medium between the broadband transmitting source 102 and the one or more wearable devices 108 around the human body 106.

The one or more wearable devices 108 (or interchangeably referred herein as wearable receiver 108) may be, for example, but not limited to, smartwatches, head-mounts, fitness trackers, smart glasses, medical equipment, and the like.

As illustrated in the figure, the human body 106 is used as a medium for transmitting data signals, typically employing techniques such as Body Area Networks (BANs) or Human Body Communication (HBC). The human body 106 conducts electrical signals naturally due to the presence of electrolytes in bodily fluids. The electrical signals may be utilized to transmit data. Data may be for example, such as audio, video, or sensor readings or the like, which may be modulated onto electrical signals. As shown in the FIG. 1A, the one or more wearable devices 108 may be integrated with a transmitter to encode the modulated data onto the electrical signals. The electrical signals may then be injected into the human body 106. In the human body 106, the electrical signals travel via conductive paths, primarily through tissues and fluids. On the receiving end, another device, which may be a computing device (not shown) or the wearable device 108, detects and interprets the modulated signals from the human body 106. The received electrical signals are demodulated to extract original data. The demodulated data is then processed, decoded, and presented to a user. In an embodiment, a server, or a system (not shown) may act as a gateway between the one or more wearable devices 108 and external systems (not shown) such as smartphones, computers, or cloud services or the like.

In an alternate embodiment, the one or more wearable devices 108 may be further connected to computing devices (not shown). The one or more computing devices may be operated by one or more users using the one or more wearable devices 108. The one or more wearable devices 108 may be connected to the computing devices via a network, such as for example. wired/wireless networks. The one or more computing devices may include, but is not limited to, a smartphone, a mobile phone, a personal digital assistant, a tablet computer, a tablet computer, a wearable device, a computer, a laptop computer, an augmented/virtual reality device (AR/VR), internet of things (IoT) device, a camera, any other device, and the combination thereof.

In an embodiment, the machine to wearable power transfer system 100 (also referred herein as network architecture 100a, or “present system 100”) includes a broadband transmitting source 102 (also referred herein as transmitting power source 102). The broadband transmitting source 102 is coupled to a ground terminal of earth. The broadband transmitting source 102 is configured to transmit power signals to one or more wearable devices 108 using one of an Electro-Quasistatic Human Body Powering and using a body-assisted power transfer. In an example embodiment, Electro-Quasistatic Human Body Powering technique utilizes the human body 106 as a conductor to transmit low-frequency electric fields. The power signals from the transmitting power source 102 induce currents within the conductive medium 106, which in turn can be used to power the wearable devices 108. In Body-assisted Power Transfer (BPT) technique, the human body 106 is used to enhance the efficiency of wireless power transfer at higher frequencies. The human body 106 may act as a resonator or scatterer, shaping the electromagnetic field generated by the transmitting power source 102 to improve power delivery to the wearable devices 108.

Further, the machine to wearable power transfer system 100 includes a conducting medium 106 communicatively coupled to the broadband transmitting source 102. In one example embodiment, the conducting medium 106 is a human body. The conducting medium 106 is configured for transferring the power signals from the transmitting power source 102 to the one or more wearable devices 108 using a human body communication network. The one or more wearable devices 108 comprise at least one wearable receiver. The at least one wearable receiver is communicatively coupled to the conducting medium 106. The at least one wearable receiver is configured to receive the power signals from the transmitting power source 102 through the conducting medium 106 via the human body communication network and charge a power unit of the at least one wearable receiver using the power signals. The wearable receiver 108 is configured to receive the power signals from the transmitting power source 102 through the conducting medium 106 via the human body communication network. The wearable receiver 108 then converts the received power signals into a usable form to charge a power unit, such as a battery, of the wearable device 108.

In an embodiment, the machine to wearable power transfer system 100 further includes a signal plate including one of a floor-based signal plate or a wall-based signal plate on which a human steps on to transmit the power through his body 106.

In an embodiment, the transmitting power source 102 is configured to simultaneously transmit the power signals at a plurality of frequencies to power the one or more wearable devices 108 operating at different resonant frequencies by tuning an inductor on a receiver end used for inductive cancellation.

In an embodiment, the transmitting power source 102 is configured to transfer the power signals at multiple frequencies to power a single wearable receiver at different resonant frequencies as a function of varying parasitic capacitances. The parasitic capacitances for the at least one wearable receiver changes with variation in a position and a posture of the one or more wearable devices 108. The resonant frequencies of the transmitting power source 102 and the resonant frequencies of the at least one wearable receiver are synchronized using an initiation sequence and a feedback mechanism. In the initiation sequence technique, during initial power-up or when a significant change in posture is detected, the wearable receiver may initiate a sequence to identify its current resonant frequency. This sequence may involve sweeping through a range of frequencies and measuring the received power at each frequency. The receiver then transmits this information back to the transmitting power source 102. Based on the feedback received from the wearable receiver, the transmitting power source 102 adjusts its own transmission frequencies to prioritize the frequency that aligns with the receiver's current resonant frequency. This ensures efficient power transfer despite variations in parasitic capacitance.

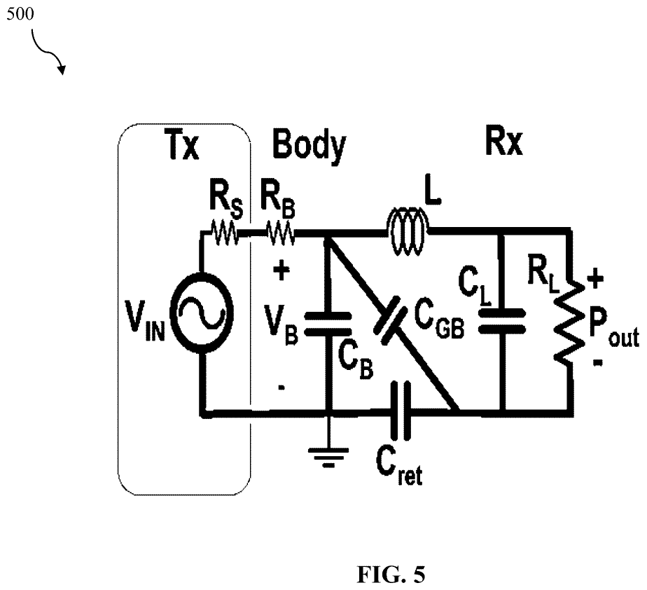

As an example for the dynamic tuning to the resonant frequency, the system shown in FIG. 1B is considered. The device shown by 108 represents a wrist worn wearable like a smartwatch. For the posture of the man shown, say the return path capacitance (Cm in FIG. 5) of the receiver is 0.5 pF. As the posture of the man changes to say a “T-pose” where the arms are outstretched, the parasitic return path capacitance increases to lets say 1 pF. This change in the parasitic capacitance occurs due to the change in the position of the wearable device with respect to the torso of the human body and further changes the resonant frequency for the inductance (“L” in FIG. 5) being the same. Thus, with a narrowband transmitter, the transmitter frequency needs to be tuned to the changed resonant frequency due to the change in posture of the person. A frequency hopping power source (102 in FIG. 1B) can detect this change in resonant frequency of the receiver. The frequency hopping powering source can be used to sweep across a range of frequencies which allows the wearable receiver to detect where the channel loss is lowest. Once the frequency for lowest channel loss is detected, this can be communicated to the transmitter using the human body communication channel formed by the grounded transmitter and the receiver. Once the new resonant frequency is communicated to the transmitter, the transmitter can transmit power at the new resonant frequency for high power transfer.

In an example scenario, consider a wearable health tracker 108 worn on the user's wrist. As the user raises their arm, the internal components of the tracker may shift slightly, causing a change in its parasitic capacitance. The transmitting power source 102, upon receiving feedback from the tracker, may adjust its transmission frequencies to prioritize the one that resonates best with the tracker's current state, ensuring optimal power delivery regardless of the user's posture. This multi-frequency approach provides several advantages such as improved power transfer efficiency. By dynamically adapting to changes in the wearable receiver's resonant frequency, the system 100 ensures efficient power transfer, even when the receiver's parasitic capacitance fluctuates. This approach allows for greater flexibility in wearable device 108 design as it mitigates the impact of position and posture variations on power reception.

In an example aspect, the method of powering a single wearable receiver using the transmitting power source 102 that transmits power signals at multiple frequencies addresses the challenge of wearable devices 108 experiencing varying parasitic capacitances due to changes in position and posture. In an example embodiment, parasitic capacitances are unintentional capacitances that exist between various components within a circuit, including the wearable receiver. These capacitances may affect the overall performance of the receiver, particularly its resonant frequency. As the user wearing the device 108 moves and changes position, the physical arrangement of the components within the receiver may shift, leading to variations in the parasitic capacitances. To address this challenge, the transmitting power source 102 in this embodiment is configured to transmit power signals at multiple frequencies. This allows the wearable receiver to potentially find a resonant frequency, regardless of the variations in its parasitic capacitance due to position and posture changes.

The transmitting power source 102 is further configured to transmit one of control sequences and a data along with the power signals for simultaneous communication and powering.

The transmitting power source 102 is in close proximity to the earth's ground with a capacitive coupling and the transmitting power source 102 transfers the power signals at one of a frequency of for example, but not limited to, less than or equal to 30 MHz, and at a frequency for example, but not limited to, between 1 MHz and 1 GHz or more.

In an example embodiment, the transmitting power source 102 is a table-top device with a capacitive coupling to the earth's ground. In this embodiment, the transmitting power source 102 utilizes capacitive coupling to establish a connection with the earth's ground. This may be achieved through a built-in conductive plate within the device that acts as one electrode of the capacitor. The other electrode may be formed by the earth itself. This capacitive coupling approach eliminates the need for a direct wired connection to the ground, simplifying the design and installation of the table-top transmitter.

In an example embodiment, the at least one wearable receiver use resonant peaking by cancelling parasitic impedances in the channel. The resonant peaking uses a combination of a receiver side resonance and a transmitter side resonance for optimal power transfer. These parasitic impedances may arise from various factors, such as the human body's impedance and the surrounding environment.

In an example embodiment, the wearable receiver may employ a technique referred to as resonant peaking to cancel out the negative effects of parasitic impedances. This technique utilizes a combination of two resonances receiver side resonance and transmitter side resonance. The wearable receiver is configured to comprise a resonant frequency that aligns with a specific frequency transmitted by the power source 102. This creates a peak in the receiver's impedance at that frequency, allowing for efficient power transfer. Similarly, the transmitting power source 102 may also be configured with a tunable resonant circuit. By adjusting this circuit, the transmitter source 102 may prioritize transmitting power at the frequency that resonates with the wearable receiver, further enhancing the overall efficiency. The combined effect of receiver-side and transmitter-side resonance creates a phenomenon known as resonant peaking. At the resonant frequency, the combined impedance of the system 100 becomes very high, allowing for maximum power transfer from the transmitter 102 to the receiver 108. The cancellation of parasitic impedances through this resonant peaking approach ensures that a larger portion of the transmitted power reaches the wearable device 108, even in the presence of interfering factors. In an example scenario, consider a user placing their smartphone 108 on a table-top transmitter 102. The transmitter 102 is configured for capacitive coupling to the ground and is configured to transmit power at a specific frequency. The smartphone, acting as the wearable receiver 108, is equipped with circuitry that creates a resonance at the same frequency. This combined resonance cancels out the parasitic impedances within the channel, allowing for efficient wireless charging of the smartphone 108 from the table-top surface.

In an example embodiment, the machine to wearable power transfer system 100 further includes a narrowband frequency hopping powering source as an alternate to the broadband transmitting power source 102 for transmitting the power signals at a plurality of frequencies. In this case, the narrowband frequency hopping powering source is configured to change a transmitter frequency for transmitting higher range power signals at a plurality of frequencies based on varying receiver resonant frequencies. In an embodiment, instead of transmitting power signals across a wide range of frequencies simultaneously, the narrowband source transmits power at a single frequency for a short duration and then hops to another frequency. This hopping pattern may cover a range of frequencies suitable for powering various wearable devices 108. The narrowband source may be configured to transmit power signals with greater strength compared to a broadband source. This allows for potentially longer-range power transfer, making it suitable for scenarios where the user might be further away from the transmitting surface.

In an example embodiment, the machine to wearable power transfer system 100 includes a load sensing on the transmitting power source 102. The load sensing is configured to selectively transfer the power signals based on one of a person's presence on the transmitting power source 102 and a code-based transmission for identifying authorized users. The changing load impedance on the transmitter changes the current sourced from the transmitter which can be detected to selectively transfer higher power when a human body is detected to be present standing on the transmitting platform. Throughout the specification, the terms “user”, “person”, “human”, may be used interchangeably.

In an example embodiment, the transmitting power source 102 may be equipped with load sensing capabilities. This allows the system 100 to detect whether there is a user or device present on the transmission surface (e.g., a table or floor mat). By only transmitting power signals when a load is detected, the system 100 conserves energy and avoids unnecessary power transmission.

Further, in the code-based transmission approach, to prevent unauthorized access to the power source, the system 100 may implement a code-based authentication mechanism. This may involve requiring a user to enter a specific code or utilize a near-field communication (NFC) tag to activate power transmission. This ensures that only authorized users may benefit from the wireless charging functionality.

In an example embodiment, the machine to wearable power transfer system 100 includes a shoe-mounted computer unit (not shown) placed in close proximity to the transmitting power source 102. The shoe-mounted computer unit is configured to receive power and communication signals from the transmitting power source 102. The shoe-mounted unit may be configured to receive power and communication signals from the transmitting power source 102. This allows for potential applications such as for example, powering wearable devices 108 integrated within the shoes or for enabling two-way communication between the user and the system 100.

In an example embodiment, the transmitting power source 102 is configured to select the best mode of power transfer from a plurality of power transfer methods. The transmitting power source 102 may be configured to select the most optimal power transfer method from a variety of available options. This selection could be based on factors such as distance between user and transmitter 102. For longer distances, the narrowband frequency hopping approach might be preferable. The other factor may be the type of wearable device 108. The system 100 may adjust its transmission parameters based on the specific power requirements of the wearable device 108 being charged. Another factor may be the presence and identification of the user. The load sensing and user authentication features may be integrated into the selection process.

As used herein the “data” may be a digital file containing multiple types of data, such as audio, video, images, and text, which may, in some instances, be integrated into a single document or presentation in formats such as MP3, MP4, JPEG, GIF, PDF, and more, depending on types of media. When transmitted over a wireless communication channel using the human body 106 as a medium, the data is converted into electrical signals that may propagate through conductive tissues of the human body 106. The electrical signals represent digital information encoded in the data. In an example embodiment, where a wearable device 108 is transmitting a multimedia stored in a digital file to another device worn by another person, or another device worn by the same person, the multimedia data file would be converted into electrical signals and transmitted through the body of a sender. The device of the receiver would then detect the electrical signals, decode the electrical signals back into the original multimedia data file, and present multimedia content to a user. In an exemplary embodiment, the conductive surface may include at least one of a human body, and a living matter. In an embodiment, the proximal device may include at least one of a wearable device 108, a handheld device, an augmented reality device, a computing device, or an earphone. The machine to wearable power transfer system 100 further generates EQS fields between the wearable device 108 and the conductive surface and between the conductive surface and the proximal device (such as for example, a computing device). The EQS fields are generated by applying a voltage on the wearable device 108. The EQS fields remain contained near the conductive surface and induce current in the proximal device. The machine to wearable power transfer system 100 may then create a communication channel for high-speed data transfer with the proximal device using the generated EQS fields and determine communication properties of the conductive surface for transmission of the multimedia data file to the proximal device. As used herein, “communication properties” may be defined as conductivity of the surface, surface area to potentially accommodate more data streams simultaneously allowing for higher data transmission rates, a degree of signal attenuation of the conductive surface, available bandwidth of the conductive surface, propagation characteristics of signals on the conductive surface such as signal dispersion and reflection, and biocompatibility of the conductive surface. The communication properties may include at least one signal strength, a signal quality, a channel capacity, and a data rate.

In an exemplary embodiment, the machine to wearable power transfer system 100 may be integrated partly or fully within the wearable device 108 and in such a case, the above-mentioned steps may be performed by the wearable device 108 itself.

Although FIG. 1A shows exemplary components of the network architecture 100A, in other embodiments, the network architecture 100A may include fewer components, different components, differently arranged components, or additional functional components than depicted in FIG. 1A. Additionally, or alternatively, one or more components of the network architecture 100A may perform functions described as being performed by one or more other components of the network architecture 100A.

FIG. 1B illustrates an example network architecture 100B for implementing a machine to wearable power transfer system for powering wearable devices 108A-N through a human body 106, in accordance with an embodiment of the present disclosure. In this FIG. 1B, a present method of powering using the human body 106 as a directed channel to on-body wearable devices 108 is disclosed. Using the conductive properties of the human body 106 for transferring power through the body and by using the body as a powering channel which connects the source 102 and wearable devices 108 is disclosed. This technique of Human Body Powering allows a low channel loss path of power transfer. A Human Body Powering (HBP), in the Electro-Quasistatic (EQS) frequency regime is used where the operating frequencies are, for example, in the range of ≤30 MHz. In the EQS frequency regime, the channel loss for power or data transfer compares favorably to those of competing wireless powering and communication techniques such as, for example, radio frequency and ultrasound for wearable devices 108 around the body 106 in various non-line-of-sight scenarios. This allows power delivery to longer channel lengths to wearable devices 108 placed all across the human body 106.

To further reduce the channel loss using EQS HBP, a machine-to-wearable architecture is disclosed where the transmitting source 102 is an earth's ground connected powering source as illustrated in FIG. 1B. Using such a wall-connected powering source allows higher power transfer firstly due to the possibility of having higher power being transmitted. Further, the use of earth's ground connected powering source reduces the channel loss by coupling higher power to the body and thus increasing the body potential.

Although FIG. 1B shows exemplary components of the network architecture 100B, in other embodiments, the network architecture 100B may include fewer components, different components, differently arranged components, or additional functional components than depicted in FIG. 1B. Additionally, or alternatively, one or more components of the network architecture 100B may perform functions described as being performed by one or more other components of the network architecture 100B.

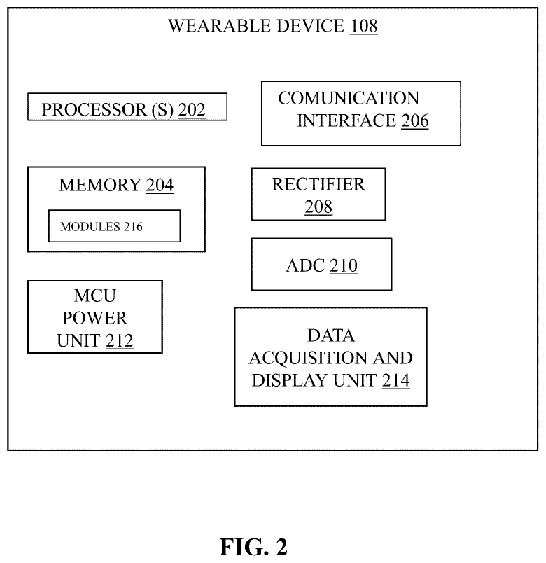

FIG. 2 illustrates an example block diagram of a wearable device 108, such as those shown in FIG. 1, for receiving power signals from a transmitting source and wirelessly charging a power source using the power signals, in accordance with an embodiment of the present disclosure. The wearable device requires an inductor in series with a rectifier which connects to an energy harvesting system consisting of say a super capacitor which stores energy.

Referring to FIG. 2, the wearable device 108 may comprise one or more processor(s) 202 that may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the wearable device 108. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as random-access memory (RAM), or non-volatile memory such as erasable programmable read only memory (EPROM), flash memory, and the like.

In an embodiment, the wearable device 108 may include a communication interface(s) 206. The communication interface(s) 206 may comprise a variety of interfaces, for example, interfaces for data input and output (I/O) devices, storage devices, and the like. The communication interface(s) 206 may also provide a communication pathway for one or more components of the wearable device 108.

In an embodiment, the memory 204 may include a plurality of modules 216 for performing one or more operations within the wearable device 108.

In an embodiment, a plurality of modules 216 may be implemented as a combination of hardware and programming (for example, programmable instructions) to implement one or more functionalities of the processor 202. In examples described herein, such combinations of hardware and programming may be implemented in several different ways. For example, the programming for the plurality of modules 216 may be processor-executable instructions stored on a non-transitory machine-readable storage medium and the hardware for the plurality of modules 216 may comprise a processing resource (for example, one or more processors), to execute such instructions. In the present examples, the machine-readable storage medium may store instructions that, when executed by the processing resource, implement the plurality of modules 216. In such examples, the wearable device 108 may comprise the machine-readable storage medium storing the instructions and the processing resource to execute the instructions, or the machine-readable storage medium may be separate but accessible to the wearable device 108 and the processing resource. In other examples, the plurality of modules 216 may be implemented by electronic circuitry.

In an embodiment, the wearable device 108 may include a signal plane, an inductor, a rectifier 208, an analog to digital converter 210, a MCU power unit 212 (also referred herein as power source 212), and a data acquisition and display unit 214. The inductor may be configured for performing inductive cancellation on the at least one wearable receiver to cancel out parasitic capacitances. The rectifier 208 may be configured to convert received alternating current (AC) signal from the transmitting power source 102 into a direct current (DC) signal.

The transmitter signal plate is used to couple power on from the power source to the human body. The receiver signal plate captures the power coupled to the body into the receiver. The inductor performs inductive cancelation of the parasitic capacitance allowing higher power to be coupled to the receiver from the body. The rectifier 208 converts the AC power collected into DC power which is stored in a super capacitor present in the energy harvesting circuitry.

In an example embodiment, the at least one wearable receiver 108 is communicatively coupled to the conducting medium 106. The at least one wearable receiver 108 is configured to receive the power signals from the transmitting power source 102 through the conducting medium 106 via the human body communication network and charge a power unit 212 of the at least one wearable receiver 108 using the power signals. Further, at least one wearable receiver 108 uses resonant peaking by cancelling parasitic impedances in the channel 106. The resonant peaking uses a combination of a receiver side resonance and a transmitter side resonance for optimal power transfer. In an embodiment, the at least one wearable receiver 108 is configured to wirelessly charge the power unit 212 via the human body 106.

Although FIG. 2 shows exemplary components of the wearable device 108, in other embodiments, the wearable device 108 may include fewer components, different components, differently arranged components, or additional functional components than depicted in FIG. 2. Additionally, or alternatively, one or more components of the wearable device 108 may perform functions described as being performed by one or more other components of the wearable device 108.

In an exemplary embodiment, the data processing, analysis, and other methods may be alternatively performed at a computing device. The wearable device 108 may be configured to stream the data to the computing device via a network.

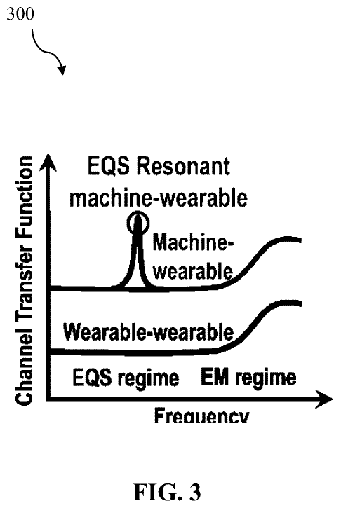

FIG. 3 illustrates an example graphical representation of a comparative results 300 of machine to wearable EQS resonance with traditional wearable to wearable and EQS regime, in accordance with an embodiment of the present disclosure. The comparative results 300 depict that the machine-to-wearable channel loss is much lesser than a traditional wearable-to-wearable channel loss due to higher signal coupling to the body. The use of a machine-to-wearable powering methodology for Human Body Powering is a first-of-its-kind approach that increases power delivery to wearable devices 108 with mW-scale power transfer possible to on-body devices 108 placed anywhere across the body 106. In conjunction with a machine-to-wearable transmitting source 102, a receiver side resonance (FIG. 3) is employed to further reduce the channel loss and increase the received power at the wearable device 108. The use of inductive cancellation results in a transfer function peaking which is illustrated with a concept in FIG. 3. Using inductive cancellation on the receiver 108 to cancel out parasitic capacitances increases the received signal on the receiver 108. Using similar concepts, receiver side resonance allows the receiver 108 to pull in higher current through the body 106, thus allowing higher power delivery. The transmitting source 102 may or may not employ resonance by using inductive cancellation, depending on the use case of the powering. In case of powering a single wearable receiver 108-1, for higher power transfer efficiency, a resonant transmitting source 102 with a resonant receiver 108 may be used for high power delivery. To power multiple wearable receivers 108-1-N, a single receiver side resonance without using transmitter side resonance allows simultaneous higher power delivery to multiple receivers 108-1-N.

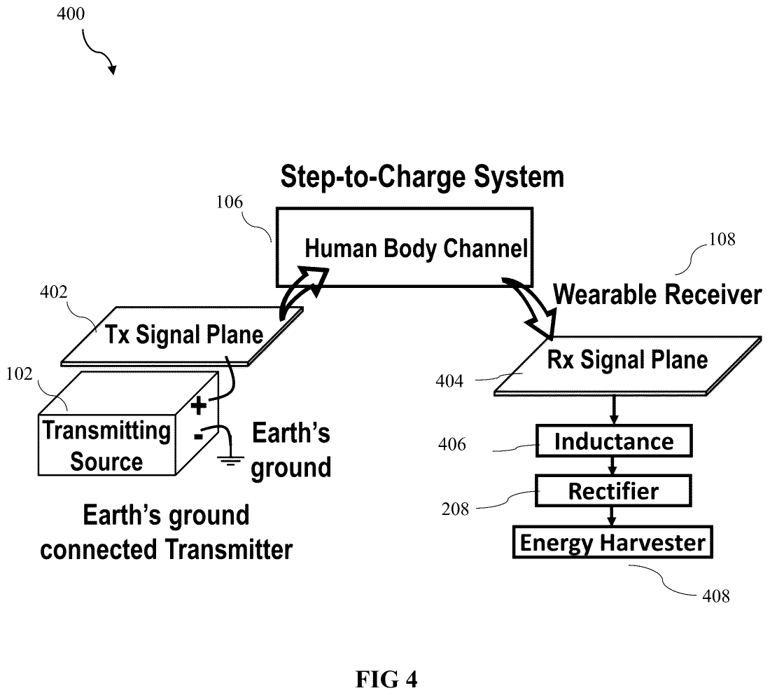

FIG. 4 illustrates an example block diagram of a machine-to-wearable electro-quasistatic resonant human body powering system 400, in accordance with an embodiment of the present disclosure. The machine-to-wearable electro-quasistatic resonant (EQS) human body powering (HBP) system 400 is similar to the network architecture 100A, 100B as shown in FIG. 1A and FIG. 1B. The machine-to-wearable electro-quasistatic resonant human body powering system 400 is similar to the machine to wearable power transfer system 100. The machine-to-wearable EQS HBP system 400 may include earth's ground connected transmitting source 102, a signal plane 402, a human body channel 106, and a wearable receiver 108. The wearable receiver 108 may include a signal plane 404 communicatively coupled to the human body channel 106, an inductor 406, a rectifier 208, and a energy harvester 408.

The signal plane 402 may be for example, but not limited to, any planar structure, positioned near the transmitting source 102, which helps to efficiently couple the power signals into the human body channel 106. Similarly, the wearable signal plane 404 enhances signal reception from the human body channel 106. The rectifier 208 circuit converts the received AC power signals from the human body channel 106 into usable DC power for the wearable device 108.

The transmitter signal plate 402 is used to couple power on from the power source to the human body 106. The receiver signal plate 404 captures the power coupled to the body into the receiver 108. The inductor 404 performs inductive cancelation of the parasitic capacitance allowing higher power to be coupled to the receiver from the body. The rectifier 208 converts the AC power collected into DC power which is stored in a super capacitor present in the energy harvesting circuitry 408. The energy harvesting circuitry consists of an energy storage element like a battery or a super capacitor. The stored energy can then be output in the form of regulated voltage from the harvesting circuitry. Energy harvesting circuits often store energy from various sources like solar power, RF-power and thermal power.

In an example embodiment, the transmitting source 102 generates power signals at a specific frequency. These signals are coupled into the human body channel 106 through the signal plane 402. The human body 106 exhibits electrical properties that influence how these signals propagate. The wearable receiver 108, specifically the inductor 406, is designed to resonate at the same frequency as the transmitted signals. This resonance phenomenon allows for efficient transfer of power from the transmitting source 102 to the wearable receiver 108. The rectifier 208 then converts the received AC signals into usable DC power for the wearable device 108.

FIG. 5 illustrates an example circuit diagram representation of a Machine-to-Wearable Electro-Quasistatic Resonant Human Body Powering channel, in accordance with an embodiment of the present disclosure. The transmitter is represented as the input voltage source (V_{IN}) and source resistance (R_{S}). The human body is emulated as a circuit using the body resistance (R_{B}) and the body capacitance (C_{B}). The parasitic capacitance between receiver signal plate and the body is represented by (C_{GB}) and the parasitic capacitance between the receiver ground plate and the earth's ground is represented as Cᵣₑₜ. The inductor (L) is used cancel out the effect of the parasitic capacitances to couple higher power into the receiver. The load on the receiver is represented as C_{L} and R_{L}. The output power is captured across the load resistance (R_{L}).

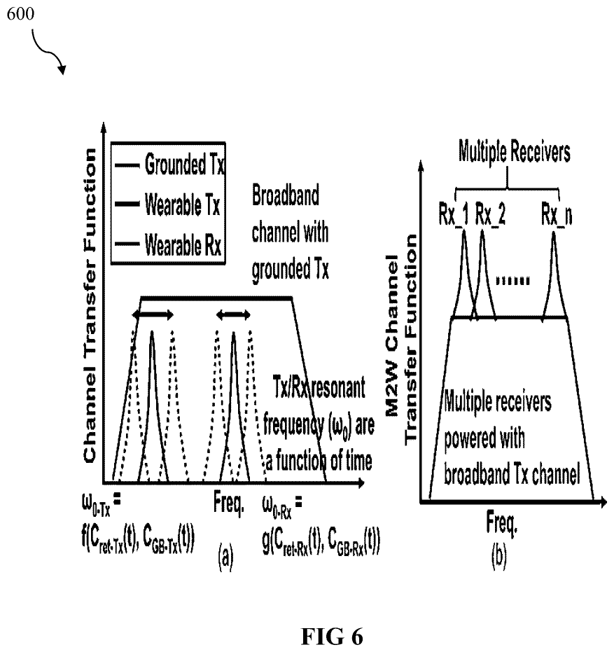

FIG. 6A-B illustrates an example graphical representation 600 of narrowband channels for the ground connected transmitter 102, a wearable transmitter and a wearable receiver, in accordance with an embodiment of the present disclosure. A broadband powering source is used using an earth's ground connected transmitter 102 which transmits high power across the EQS-frequency regime of up to 30 MHz. FIG. 6 depicts the use of a broadband channel available with a Machine-to-Wearable EQS Resonant Human Body Powering channel. In traditional Wearable-to-Wearable power transfer, a resonance is required on both the transmitter and the receiver for higher power delivery. The narrowband channels for the transmitter and receiver have a resonant peak which is a function of the parasitic capacitances which may vary with time as shown in FIG. 6A. Thus, it becomes very difficult to align the transmitter and receiver resonant peaks and is impossible to power multiple receivers at the same time. With a broadband low channel loss channel available with a ground connected transmitting source 102, powering of multiple receivers 108 at different frequencies simultaneously by tuning the inductor 406 used for inductive cancellation on the receiver end 108 is possible as shown in FIG. 6B. This allows mW-scale power transfer to multiple receivers simultaneously which otherwise using conventional Wearable-to-Wearable powering is not achievable. Furthermore, the present invention provides simultaneous communication using an earth's ground connected source 102 allowing to transmit data or control sequences on top of the powering signal, which is termed as modulated powering, all of which is made possible with body-assisted communication and powering with the concepts of Human Body Communication and Human Body Powering.

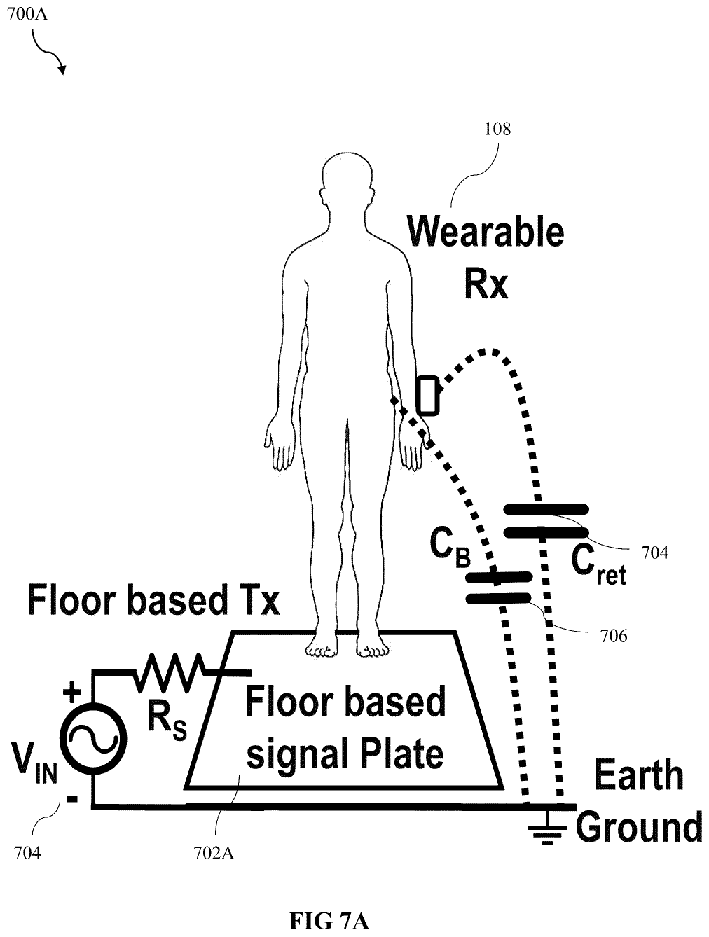

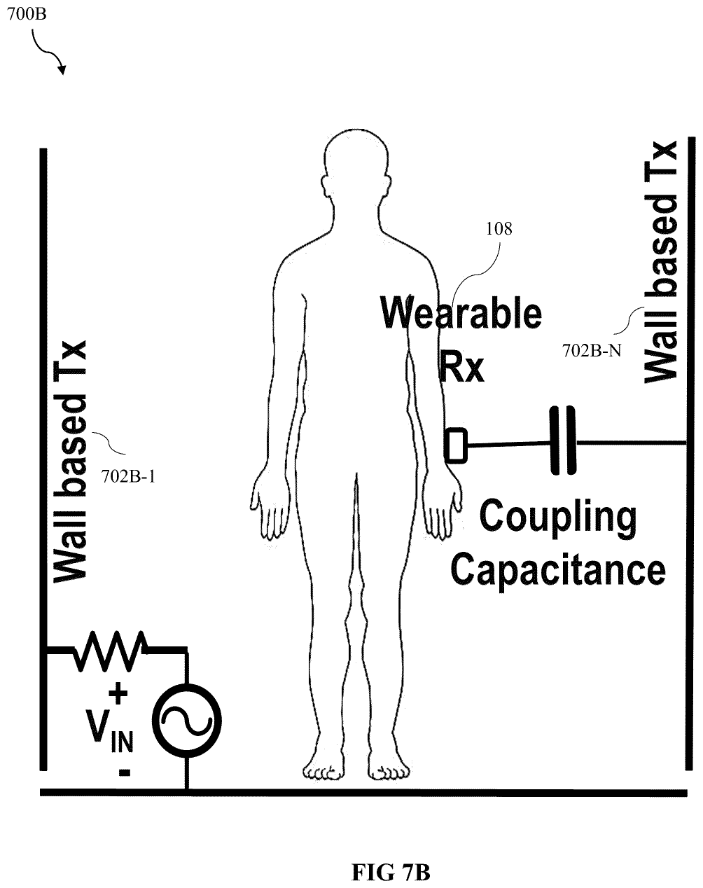

FIG. 7A illustrates an example schematic representation of a floor-based earth's ground connected powering methodology using Electro-Quasistatic Resonant Human Body Powering, in accordance with an embodiment of the present disclosure. FIG. 7B illustrates an example schematic representation of a wall-connected powering methodology using Electro-Quasistatic Resonant Human Body Powering, in accordance with an embodiment of the present disclosure. From an application point of view, a floor-based earth's ground connected powering methodology is disclosed using Electro-Quasistatic Resonant Human Body Powering. In this FIG. 7A, the signal plate of the wall connected transmitting source 702A may be for example, but not limited to, a floor of a room or a powering station. This ensures that the person wearing the on-body wearable receivers 108 is always in close proximity to the transmitting source 702A and there is a seamless delivery of high power through the human body 106 using a Machine-to-Wearable Resonant Human Body Powering architecture. This may further be extended to include walls of rooms 702B-1 and 702B-N as the signal plate of transmitting source as shown in FIG. 7B. Thus, in a powering station, with the floor and/or the walls of the rooms being the signal plate of the earth's ground connected powering source allows to couple higher power on to the body 106 and receiver side resonance allows higher power to be delivered to the receiver. This in conjunction with the Machine-to-Wearable Human Body Powering architecture creates a low path loss channel allowing mW-scale powering of multiple receivers simultaneously which are connected to the human body 106.

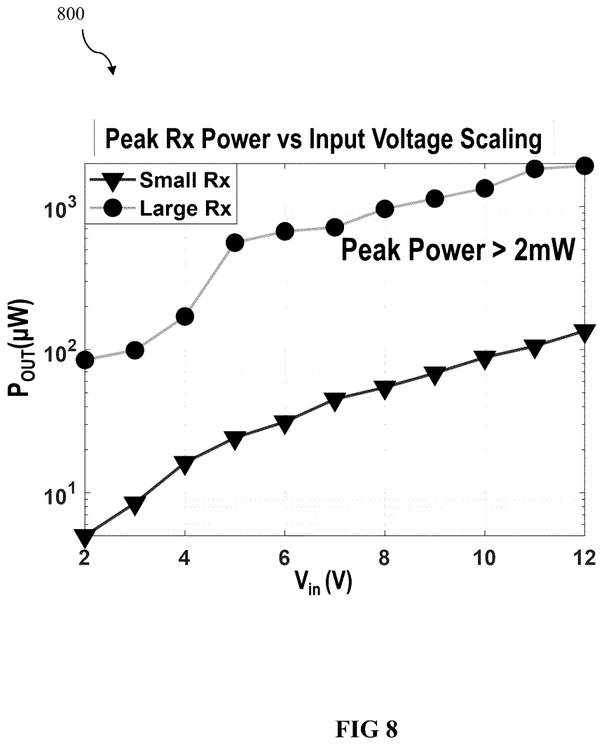

FIG. 8 illustrates an example graphical representation of experimental results 800 with a floor-based earth's ground connected powering source, in accordance with an embodiment of the present disclosure. To demonstrate the feasibility of the Machine-To-Wearable Broadband Electro-Quasistatic Resonant Human Body Powering, experiments with a floor-based earth's ground connected powering source are performed. The experimental results are illustrated in FIG. 8. In one example, the powering source may be a function generator (Rigol DG4202) capable of transmitting a sinusoidal wave connected to a signal plane on the floor made from aluminum foil and jumper wires connecting the output from the function generator to the aluminum foil. The function generator is plugged into the wall power outlet, connecting the device to the earth's ground. Three different receivers (Rx1, Rx2, Rx3) are used with a peak received power of more than 2 mW achieved with a wearable receiver for an input voltage of 12 V peak-to-peak demonstrating the mW-scale power transfer possible with a Machine-to-Wearable Broadband EQS Resonant HBP.

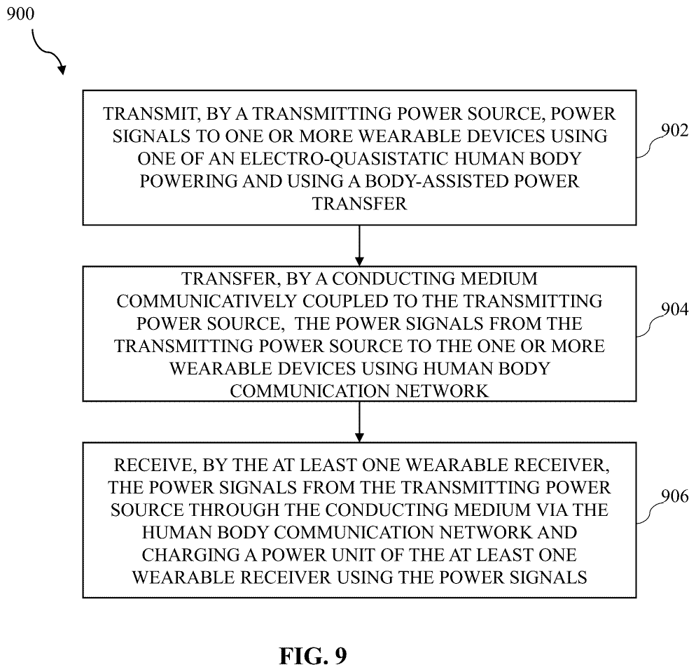

FIG. 9 illustrates an example flow chart depicting an example process of powering wearable devices through a human body, in accordance with an embodiment of the present disclosure. At step 902, the method 900 includes transmitting, by a transmitting power source 102, power signals to one or more wearable devices 108 using one of an Electro-Quasistatic Human Body Powering and using a body-assisted power transfer. At step 904, the method 900 includes transferring, by a conducting medium 106 communicatively coupled to the transmitting power source 102, the power signals from the transmitting power source 102 to the one or more wearable devices 108 using human body communication network. The one or more wearable devices 108 comprise at least one wearable receiver. At step 906, the method includes receiving, by the at least one wearable receiver 108, the power signals from the transmitting power source through the conducting medium 106 via the human body communication network.

The method 900 further comprises simultaneously transmitting, by the transmitting power source 102, the power signals at a plurality of frequencies to power the one or more wearable devices operating at different resonant frequencies by tuning an inductor on a receiver end used for inductive cancellation.

The method 900 further comprises transferring, by the transmitting power source 102, the power signals at multiple frequencies to power a single wearable receiver at different resonant frequencies as a function of varying parasitic capacitances. The parasitic capacitances for the at least one wearable receiver changes with variation in a position and a posture of the one or more wearable devices 108. With changing position or posture of the human, the parasitic capacitances (Cᵣₑₜ and C_{GB}) vary as explained in [0051]. This variance in parasitic capacitance changes the resonant frequency of the receiver. However, as the transmitter can be a broadband source which transmits across a broad frequency range, the variance in resonant frequency of the receiver is still within this broadband frequency range of the transmitter and thus high power can still be delivered to the receiver. For example, if the transmitter is transmitting power at frequencies of 1-5 MHz, the receiver resonant frequency can vary between 1-5 MHz due to change in parasitic capacitance values and still receive high power as the transmitter is supplying high power at all such frequencies.

The method 900 further comprises synchronizing, by the transmitting power source 102, the resonant frequencies of the transmitting power source and the resonant frequencies of the at least one wearable receiver using an initiation sequence and a feedback mechanism. The circuit model illustrated in FIG. 5 is valid for communicating data as well as transmitting power to a wearable receiver. Thus, using the human body as a channel for communicating data using the same mechanism as transmitting power, we can transmit initiation sequences which are lower power signals to the wearable receiver using the human body channel. The initiation sequence is coupled to the human body using the grounded transmitter and the human body channel carries the sequence to the receiver connected to the body which can be decoded at the receiver using a simple decoder. Further, data can be transmitted from the wearable device to the grounded powering source using the human body as well by using the signal plate of the wearable device as a means to couple data on to the body which is then carried by the human body channel to the transmitter signal plate which is close to the body.

The method 900 further comprises transmitting, by the transmitting power source 102, one of control sequences and a data along with the power signals for simultaneous communication and powering to the one or more wearable device 108s. Data transfer from the grounded powering source to a wearable receiver occurs using the same mechanism as described in [0091] by using the human body as a communication medium. The conductive properties of the human body tissues carry data from the grounded transmitter to a wearable receiver as in the case of a standard Human Body Communication system. Thus, the power source can transmit data along with power to the receiver by coupling data signals on to power signals transmitted through the body which is then decoupled at the receiver.

The method 900 further comprises performing resonant peaking by cancelling parasitic impedances in communication channel. The resonant peaking uses a combination of a receiver side resonance and a transmitter side resonance for optimal power transfer. Resonance using an additional inductance (L) in the circuit model shown in FIG. 5 allows the canceling of the parasitic capacitances (Cᵣₑₜ, C_{GB}). This allows higher power to be coupled with the body resulting in higher power transfer to the receiver. The voltage transfer function of the circuit shown in FIG. 5 at the resonant frequency:

$$( {ω}_{o} = \frac{1}{\sqrt{L \times ( {C}_{ret} + {C}_{GB} )}} ) \qquad equation ( l )$$

is given by Eqn. 1:

$$\frac{{V}_{o}}{{V}_{B}} = \frac{{C}_{ret}}{{C}_{ret} + {C}_{GB}} \qquad equation ( 2 )$$

which is the maximum received potential on the body available using receiver side resonance.

The method 900 further comprises transmitting, by a narrowband frequency hopping powering source, the power signals at a plurality of frequencies; and changing, by the narrowband frequency hopping powering source, a transmitter frequency for transmitting higher range power signals at a plurality of frequencies based on varying receiver resonant frequencies.

The method 900 further comprises selectively transferring, by a load sensing unit, the power signals based on one of a person's presence on the transmitting power source 102 and a code-based transmission for identifying authorized users.

The method 900 further comprises selecting, by the transmitting power source 102, a best mode of power transfer from a plurality of power transfer methods. The transmitting power source can be a floor-based or a wall-based unit. Further, the transmitting powering source may include transmitter side resonance for inductive cancellation of parasitic capacitance to increase power transfer efficiency. The transmitter may be a wearable unit with the same power transfer methodologies and simultaneous data transfer to wearable units. The transmitter can also have a combination of the techniques described in above paragraphs. The optimum power transmitting source is dependent on the use cases. For example, general powering of multiple wearables at the same time may require us to use a broadband powering source. On the other hand, if the intent is to power a single wearable, a narrowband powering source with dynamic frequency tuning to select the resonant frequency may be a better choice for efficient power transfer.

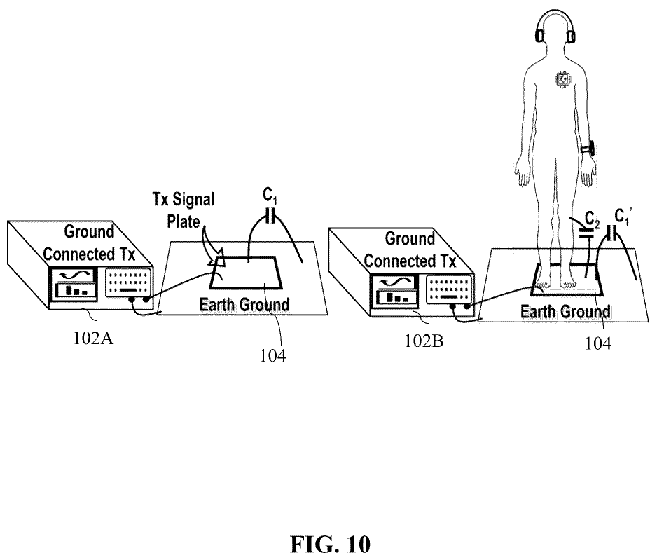

FIG. 10 illustrates an example schematic representation of a load sensing circuit, in accordance with an embodiment of the present disclosure. The present disclosure discloses use of load sensing on the transmitter 102. The system 100 allows selective power transfer only when a person is standing on the transmitting source 102 or is close to the transmitting source 102. Selective power transfer depending on the person standing or a code-based transmission to allow selectivity of powering wearables is disclosed. A unique ID or a code may be sent from the receiver to the transmitter 102 which allows identification of the person who is interacting with the transmitting source 102. In an example embodiment, the machine to wearable power transfer system 100 includes a load sensing on the transmitting power source 102. The load sensing is configured to selectively transfer the power signals based on one of a person's presence on the transmitting power source 102 and a code-based transmission for identifying authorized users. The changing load impedance on the transmitter changes the current sourced from the transmitter which can be detected to selectively transfer higher power when a human body is detected to be present standing on the transmitting platform.

In an example embodiment, the transmitting power source 102 may be equipped with load sensing capabilities. This allows the system 100 to detect whether there is a user or device present on the transmission surface (e.g., a table or floor mat). By only transmitting power signals when a load is detected, the system 100 conserves energy and avoids unnecessary power transmission.

Further, in the code-based transmission approach, to prevent unauthorized access to the power source, the system 100 may implement a code-based authentication mechanism. This may involve requiring a user to enter a specific code or utilize a near-field communication (NFC) tag to activate power transmission. This ensures that only authorized users may benefit from the wireless charging functionality. The presence of a human on the signal plate changes the load impedance. Without the human there is only a single capacitance (C₁). Human standing on the Tₓ signal plate 104 changes the load capacitances which changes the current sourced through the Tₓ.

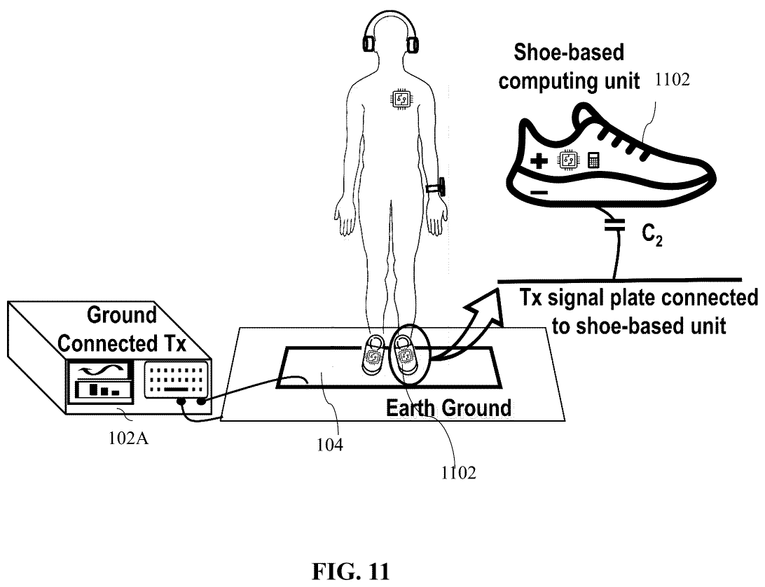

FIG. 11 illustrates an example schematic representation of a shoe based wearable computing unit in accordance with an embodiment of the present disclosure. The machine to wearable power transfer system 100 further comprises a shoe-mounted computer unit 1102 placed in close proximity to the transmitting power source 102. The shoe-mounted computer unit 1102 is configured to receive power and communication signals from the transmitting power source 102.

In an example embodiment, the machine to wearable power transfer system 100 includes a shoe-mounted computer unit (not shown) placed in close proximity to the transmitting power source 102. The shoe-mounted computer unit is configured to receive power and communication signals from the transmitting power source 102. The shoe-mounted unit may be configured to receive power and communication signals from the transmitting power source 102. This allows for potential applications such as for example, powering wearable devices 108 integrated within the shoes or for enabling two-way communication between the user and the system 100.

The present disclosure in general relates to mW-scale power transfer through the human body. Specifically, the present disclosure demonstrates, for the first time mW-scale power transfer to body-connected devices across the body including channel lengths exceeding 1 m. The use of a different modality, with a strongly earth's ground coupled device to wearable (termed as Machine-to-Wearable) Resonant Human Body Powering allows a lower channel loss system to transfer higher power through the body to wearable devices. The features of this powering methodology are 1) Using Electro-Quasistatic (EQS) Human Body Powering (HBP) at frequencies of ≤30 MHz, which contains the transmitted power through the body to channel it to a receiver connected to the body, 2) Low channel loss powering channel through the body to wearable devices using Machine-to-Wearable Human Body Channel, 3) Higher power delivery using a wall connected powering source, 4) Use of receiver side resonance for higher power delivery, 5) Use of transmitter side resonance for higher power transfer efficiency, 6) Powering multiple wearable devices around the body with a broadband transmitting source, 7) Powering via a floor-based transmitting source to a wearable device connected anywhere across the body, 8) Powering via a wall-based transmitting source to wearable devices connected anywhere across the body, 9) Powering using an earth's ground connected source in close proximity to the body to a wearable device connected anywhere across the body, 10) Modulated powering to allow simultaneous powering and communication from a strongly earth's ground coupled source to and from a wearable receiver.

The present disclosure provides a method of powering wearable devices through the human body 106 using a broadband Electro-Quasistatic Resonant Human Body Powering using a Machine-to-Wearable architecture enabling a lower channel loss than typical Wearable-to-Wearable methodologies resulting in mW-Scale power transfer to multiple wearable devices across the body. Specifically, the present disclosure provides a power transfer through a human body 106 using Electro-Quasistatic Human Body Powering operating at frequencies≤30 MHz and/or operating at frequencies between 1 MHz-1 GHz using body assisted power transfer. Further, the present discloses power transfer through the human body using a strongly earth's ground coupled device including a powering source has a direct contact with the earth's ground or is a ground connected device. Alternatively, the powering source may be a wall-connected with strong coupling to earth's ground or the powering source may be in close proximity to the earth's ground with a large capacitive coupling to the earth's ground or the powering source may be a table-top device with a large capacitive coupling to the earth's ground.

In an example, the present disclosure discloses a power transfer mechanism using a strong earth's ground coupled transmitter to wearable receiver with Human Body Powering platform using the powering source 102. In an example, the power source may have operating frequency in the Electro-Quasistatic frequency regime of ≤30 MHz or operating frequency beyond Electro-Quasistatic frequency regime using body assisted powering.

In an example, the present disclosure discloses a low channel loss power transfer channel using strong earth's ground coupled transmitter to wearable receiver with Human Body Powering with use of a large powering source with a strong capacitive coupling to the earth's ground. A low parasitic impedance to the earth's ground resulting in a high signal coupling to the body resulting in low channel loss is further disclosed. Further, the use of resonant peaking to further reduce channel loss of the system is disclosed. Also, using receiver side resonance to cancel parasitic impedances in the channel reducing the channel loss of the system is disclosed. Additionally, using transmitter side resonance to cancel parasitic impedances in the channel reducing the channel loss of the system is disclosed.

Additionally, using receiver and transmitter side resonance simultaneously to cancel parasitic impedances in the channel reducing the channel loss of the system and increase power transfer efficiency is disclosed. The use of an initiation sequence and feedback, which allows the synchronization of the transmitter and receiver's resonant frequency for maximum power transfer is disclosed.

Furthermore, the use of a strong ground coupled transmitter allowing broadband low-path-loss power transmitting channel achieved with a powering source. Powering multiple receivers simultaneously using body assisted power transfer is also disclosed. Additionally, the use of power transfer at multiple frequencies to power a single wearable receiver at different resonant frequencies as a function of varying parasitic capacitance is disclosed. As the parasitic capacitances for the wearable receiver change with variation in position and posture, the resonant frequency varies. However, the receiver still picks up a high power from the transmitter due to the broadband transmitted signal.

In an example, the present disclosure discloses a narrowband frequency hopping powering source that allows changing transmitter frequency to transmit high power at multiple frequencies to adapt to varying receiver resonant frequencies. The system adapts to the dynamic variations of the resonant frequency due to the variation in parasitic capacitances for the wearable receiver change with variation in position and posture to transfer high power. Further, the system uses a floor-based signal plate for the transmitter which is the powering source ensuring proximity to the human body. Also, the use of a conductive carpet as the floor-based signal plate is disclosed. Furthermore, the use of elevated planks on top of the earth's ground to increase signal coupling to transmit higher power through the body is disclosed.

The present disclosure discloses use of covert transmitting sources for simultaneous communication and powering with a stealthy transmitter. Also, the use of other designs of floor-based transmitting source on which a human can step on to transmit power through the body is disclosed.

The present disclosure discloses use of a wall-based signal plate for the transmitter which is the powering source ensuring proximity to the human body, use of conductive carpets as the wall-based signal plate, use of planks further away from the earth's ground to increase signal coupling to transmit higher power through the body, use of covert transmitting sources for simultaneous communication and powering with a stealthy transmitter and use of other designs of wall-based transmitting source on which a human can step on to transmit power through the body.

The present disclosure discloses simultaneous communication and powering using modulated power transfer. The present system allows communication of signals like control sequences from the transmitter to the receiver and allows communication of data along with powering of the receiver. Interaction between floor and/or a wall-based power and communication transmitter unit and shoe mounted computer unit is also disclosed. This enables higher power transfer and low communication power loss through a shoe-based computing unit due to close proximity from the transmitting source.

Further, present disclosure discloses use of load sensing on the transmitter. The system allows selective power transfer only when a person is standing on the transmitting source or is close to the transmitting source. Selective power transfer depending on the person standing or a code-based transmission to allow selectivity of powering wearables is disclosed. A unique ID or a code may be sent from the receiver to the transmitter which allows identification of the person who is interacting with the transmitting source.

Furthermore, the present disclosure discloses continuous optimal power transfer by choosing between multiple wireless powering methodologies. In the absence of a strongly ground coupled transmitter, the use of a wearable or smaller form factor transmitter for power transfer to another wearable receiver is disclosed.

One of the ordinary skills in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, a. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A machine to wearable power transfer system for powering wearable devices through a human body, comprising:
a transmitting power source is coupled to a ground terminal of earth, wherein the transmitting power source is configured to transmit power signals to one or more wearable devices using one of an Electro-Quasistatic Human Body Powering and using a body-assisted power transfer;
a conducting medium communicatively coupled to the transmitting power source, wherein the conducting medium is configured for transferring the power signals from the transmitting power source to the one or more wearable devices using a human body communication network, wherein the one or more wearable devices comprise at least one wearable receiver; and
the at least one wearable receiver communicatively coupled to the conducting medium, wherein the at least one wearable receiver is configured to receive the power signals from the transmitting power source through the conducting medium via the human body communication network.

2. The machine to wearable power transfer system of claim 1, further comprising a signal plate comprising one of a floor-based signal plate and a wall-based signal plate on which a human steps on to transmit the power through body.

3. The machine to wearable power transfer system of claim 1, wherein the transmitting power source is configured to simultaneously transmit the power signals at a plurality of frequencies to power the one or more wearable devices operating at different resonant frequencies by tuning an inductor on a receiver end used for inductive cancellation.

4. The machine to wearable power transfer system of claim 1, wherein the transmitting power source is configured to transfer the power signals at multiple frequencies to power a single wearable receiver at different resonant frequencies as a function of varying parasitic capacitances, wherein the parasitic capacitances for the at least one wearable receiver changes with variation in a position and a posture of the one or more wearable devices.

5. The machine to wearable power transfer system of claim 4, wherein the resonant frequencies of the transmitting power source and the resonant frequencies of the at least one wearable receiver is synchronized using an initiation sequence and a feedback mechanism.

6. The machine to wearable power transfer system of claim 1, wherein the transmitting power source is further configured to transmit one of control sequences and a data along with the power signals for simultaneous communication and powering of the one or more wearable devices.

7. The machine to wearable power transfer system of claim 1, wherein the transmitting power source is in close proximity to the earth's ground with a capacitive coupling and wherein the transmitting power source transfers the power signals at one of a frequency of less than or equal to 30 MHz, and at a frequency between 1 MHz and 1 GHz.

8. The machine to wearable power transfer system of claim 1, wherein the transmitting power source is a table-top device with a capacitive coupling to the earth's ground.

9. The machine to wearable power transfer system of claim 1, wherein the at least one wearable receiver uses resonant peaking by cancelling parasitic impedances in the channel, wherein the resonant peaking uses a combination of a receiver side resonance and a transmitter side resonance for optimal power transfer.

10. The machine to wearable power transfer system of claim 1, further comprising a narrowband frequency hopping powering source for transmitting the power signals at a plurality of frequencies and wherein the narrowband frequency hopping powering source is configured to change a transmitter frequency for transmitting higher range power signals at a plurality of frequencies based on varying receiver resonant frequencies.

11. The machine to wearable power transfer system of claim 1, further comprising a load sensing on the transmitting power source configured to selectively transfer the power signals based on one of a person's presence on the transmitting power source and a code-based transmission for identifying authorized users.

12. The machine to wearable power transfer system of claim 1, further comprising: a shoe-mounted computer unit placed in close proximity to the transmitting power source, wherein the shoe-mounted computer unit is configured to receive power and communication signals from the transmitting power source.

13. The machine to wearable power transfer system of claim 1, wherein the transmitting power source is configured to select a best mode of power transfer from a plurality of power transfer methods.

14. The machine to wearable power transfer system of claim 1, wherein the conducting medium is a human body.

15. The machine to wearable power transfer system of claim 1, wherein the at least one wearable receiver comprises:
a signal plane;
an inductor configured for performing inductive cancellation on the at least one wearable receiver to cancel out parasitic capacitances; and
a rectifier configured to convert received alternating current (AC) signal from the transmitting power source into a direct current (DC) signal.

16. A machine to wearable power transfer method for powering wearable devices through a human body, comprising:
transmitting, by a transmitting power source, power signals to one or more wearable devices using one of an Electro-Quasistatic Human Body Powering and using a body-assisted power transfer;
transferring, by a conducting medium communicatively coupled to the transmitting power source, the power signals from the transmitting power source to the one or more wearable devices using human body communication network wherein the one or more wearable devices comprise at least one wearable receiver; and
receiving, by the at least one wearable receiver, the power signals from the transmitting power source through the conducting medium via the human body communication network.

17. The machine to wearable power transfer method of claim 16, further comprising: simultaneously transmitting, by the transmitting power source, the power signals at a plurality of frequencies to power the one or more wearable devices operating at different resonant frequencies by tuning an inductor on a receiver end used for inductive cancellation.

18. The machine to wearable power transfer method of claim 16, further comprising: transferring, by the transmitting power source, the power signals at multiple frequencies to power a single wearable receiver at different resonant frequencies as a function of varying parasitic capacitances, wherein the parasitic capacitances for the at least one wearable receiver changes with variation in a position and a posture of the one or more wearable devices.

19. The machine to wearable power transfer method of claim 18, further comprising:
synchronizing, by the transmitting power source, the resonant frequencies of the transmitting power source and the resonant frequencies of the at least one wearable receiver using an initiation sequence and a feedback mechanism.

20. The machine to wearable power transfer method of claim 16, further comprising: transmitting, by the transmitting power source, one of control sequences and a data along with the power signals for simultaneous communication and powering to the one or more wearable devices.

21. The machine to wearable power transfer method of claim 16, further comprising performing resonant peaking by cancelling parasitic impedances in communication channel, wherein the resonant peaking uses a combination of a receiver side resonance and a transmitter side resonance for optimal power transfer.

22. The machine to wearable power transfer method of claim 16, further comprising:
transmitting, by a narrowband frequency hopping powering source, the power signals at a plurality of frequencies; and
changing, by the narrowband frequency hopping powering source, a transmitter frequency for transmitting higher range power signals at a plurality of frequencies based on varying receiver resonant frequencies.

23. The machine to wearable power transfer method of claim 16, further comprising: selectively transferring, by a load sensing unit, the power signals based on one of a person's presence on the transmitting power source and a code-based transmission for identifying authorized users.

24. The machine to wearable power transfer method of claim 16, further comprising: selecting, by the transmitting power source, a best mode of power transfer from a plurality of power transfer methods.

25. A non-transitory computer-readable medium comprising machine-readable instructions that are executable by a processor to:
transmit power signals to one or more wearable devices using one of an Electro-Quasistatic Human Body Powering and using a body-assisted power transfer;
transfer the power signals from the transmitting power source to the one or more wearable devices using human body communication network wherein the one or more wearable devices comprise at least one wearable receiver; and
receive the power signals from the transmitting power source through the conducting medium via the human body communication network.
